(19) United States
(12) Patent Application Publication
(10) Pub. No.: US 2004/0235515 A1
(43) Pub. Date: Nov. 25, 2004

(54) Dual frequency wireless network access device

(76) Inventor: Jesse Kao, Hsin Chuang City (TW)

Correspondence Address: Jesse Kao, P.O.Box 4-67, Hsin Chuang, Taipei, TW

(21) Appl. No.: 10/443,700

(22) Filed: May 20, 2003

(51) Int. Cl. H04M 1/00

(52) U.S. Cl. 455/552.1; 455/553.1

(57) ABSTRACT

A dual or multiple wireless network access device is used for communicating between network systems and end users of different frequencies, and includes a processor device for coupling to the network systems, a dual frequency wireless circuit coupled to the processor device, an antenna coupled to the dual frequency wireless circuit to receive and transmit signals of a frequency, and another antenna coupled to the dual frequency wireless circuit to receive and transmit signals of a different frequency, and thus to allow the end users of different frequencies to communicate with the network systems via the dual frequency wireless circuit.

### BACKGROUND OF THE INVENTION

1. Field of the Invention

The present invention relates to a wireless network access device, and more particularly to a dual or multiple wireless network access device for receiving and transmitting or processing signals of two or more different frequencies.

2. Description of the Prior Art

Various kinds of network systems have become more and more popular nowadays. Heretofore, the computers of the end users are required to be coupled to or communicated with the network systems with or via cable connections. However, the cable connected network systems are inconvenient for both the end users and the network system providers.

Recently, wireless network systems have become more and more popular, and have mostly substituted the cable connected network systems. For entering into or for communicating with the wireless network systems, various kinds of wireless network access devices are required to be prepared and provided for coupling to or for communicating the computers of the end users with the wireless network systems.

The typical wireless network systems have provide a number of different frequencies for being communicated between the computers of the end users and the wireless network systems. For example, at least 802.11a, 802.11b, and 802.11g of the institute of electrical and electronic engineers (IEEE), i.e., at least three different frequencies: IEEE 802.11a, IEEE 802.11b, and IEEE 802.11g have been provided and used for the typical wireless network systems.

However, the typical wireless network access devices comprise a processor device coupled to a high frequency antenna, such as 5 GHz antenna via an access control circuit and a wireless module, for receiving and/or transmitting high frequency signals, such as IEEE 802.11a, and coupled to a low frequency antenna, such as 2.4 GHz antenna via another access control circuit and another wireless module, for receiving and/or transmitting low frequency signals, such as IEEE 802.11b or IEEE 802.11g.

Accordingly, two or more access control circuits and two or more wireless module are required to be provided in the typical wireless network access devices, for allowing the end users to be communicated with the wireless network systems with two or more different frequencies. The typical wireless network access devices may thus consume much electric energy.

In addition, when one of the end users is communicated with the wireless network systems with one of the frequencies, such as the high frequency signals IEEE 802.11a, the other end users may have to wait until the previous end users have been completed the communication with the wireless network systems with the high frequency signals IEEE 802.11a, before the other end users may be communicated with the wireless network systems with the other frequencies, such as the low frequency signals IEEE 802.11b or IEEE 802.11g.

The present invention has arisen to mitigate and/or obviate the afore-described disadvantages of the conventional wireless network access devices.

### SUMMARY OF THE INVENTION

The primary objective of the present invention is to provide a dual or multiple wireless network access device having a simplified configuration for receiving and/or transmitting signals of two or more different frequencies.

In accordance with one aspect of the invention, there is provided a dual or multiple wireless network access device comprising a wireless network access device for communicating between network systems and end users of different frequencies, the wireless network access device comprising a processor device for coupling to the network systems, a dual frequency wireless circuit coupled to the processor device, a first antenna coupled to the dual frequency wireless circuit to receive and transmit signals of a frequency, and a second antenna coupled to the dual frequency wireless circuit to receive and transmit signals of a frequency different from that of the first antenna, and to allow the end users of different frequencies to communicate with the network systems via the dual frequency wireless circuit.

A wireless control device may further be provided and coupled between the dual frequency wireless circuit and the processor device, to transmit signals between the dual frequency wireless circuit and the processor device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a dual or multiple wireless network access device in accordance with the present invention;

FIG. 2 is a plan schematic view illustrating the operation of the dual or multiple wireless network access device; and

FIG. 3 is a diagram illustrating the operation of the dual or multiple wireless network access device.

### DETAILED DESCRIPTION OF THE PREFERRED EMBODIMENT

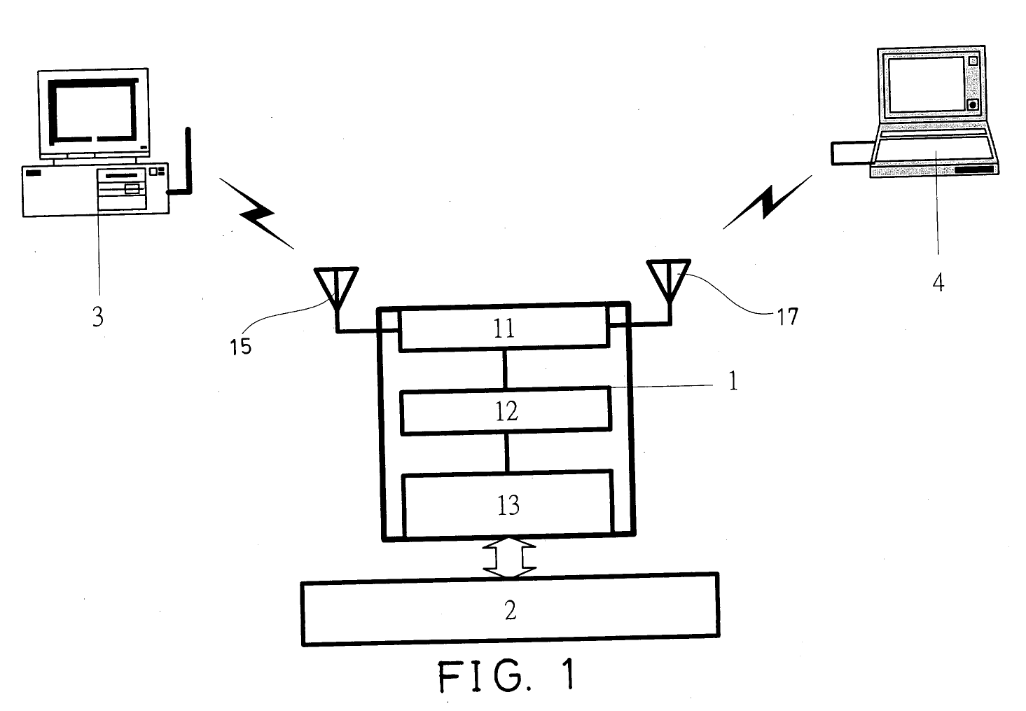

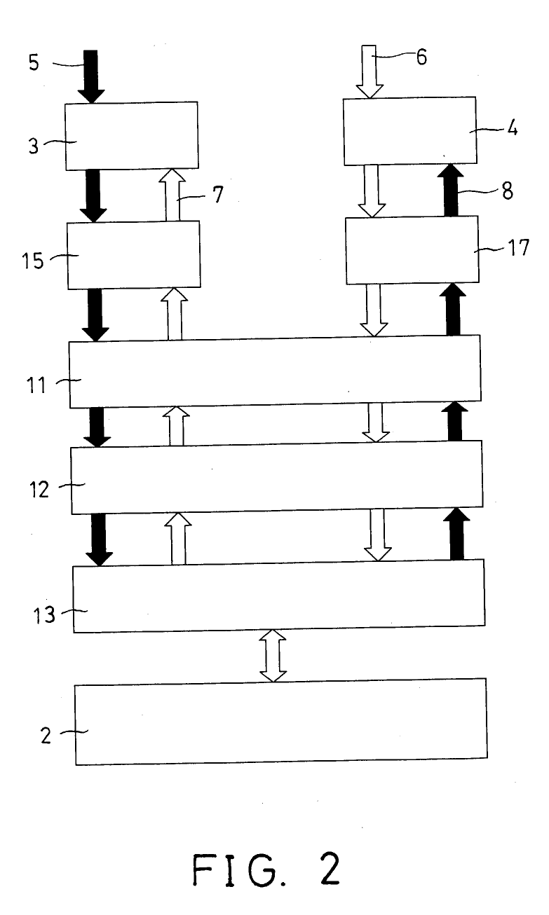

Referring to the drawings, and initially to FIGS. 1 and 2, a dual or multiple wireless network access device 1 in accordance with the present invention comprises a dual frequency wireless module or circuit 11 coupled to a processor device 13 directly, or indirectly via a wireless control circuit or device 12.

The processor device 13 may be coupled to various network systems 2, such as local area network systems, wireless local area network systems, etc., in order to access into or to communicate with the network systems 2, and to process and/or detect and/or transmit signals to and from the network systems 2.

An antenna 15 is coupled to the dual frequency wireless circuit 11 of the wireless network access device 1 for receiving and/or transmitting low frequency signals (2.4 GHz), such as IEEE 802.11b or IEEE 802.11g, between the dual frequency wireless circuit 11 of the wireless network access device 1 and the end users 3 who also use low frequency signals, such as IEEE 802.11b or IEEE 802.11g.

Another antenna 17 is also coupled to the dual frequency wireless circuit 11 of the wireless network access device 1 for receiving and/or transmitting high frequency signals (5 GHz), such as IEEE 802.11a, between the dual frequency wireless circuit 11 of the wireless network access device 1 and the end users 4 who also use high frequency signals, such as IEEE 802.11a.

The dual frequency wireless circuit 11 of the wireless network access device 1 is provided to receive and/or transmit and/or process both the high and low frequency wireless signals to and from the antennas 15, 17 of different frequencies, and to convert the wireless signals of different frequencies into package or digital signals.

The wireless control device 12 is coupled between the dual frequency wireless circuit 11 and the processor device 13, to receive and/or transmit and/or process the package or digital signals between the dual frequency wireless circuit 11 and the processor device 13, and thus to allow the end users 4 of different frequencies to be communicated with the network systems 2, and to be communicated with each other.

In operation, as shown in FIG. 2, for example, the end users 3, 4 of different frequencies may be transmitted signals or may be communicated with the network systems 2 via the dual frequency wireless circuit 11 and the processor device 13, as shown by black and white or hollow arrows 5, 6, and may receive signals from the network systems 2 via the dual frequency wireless circuit 11 and the processor device 13, as shown by black and white or hollow arrows 7, 8 respectively, such that the end users 3, 4 of different frequencies may also be communicated with each other.

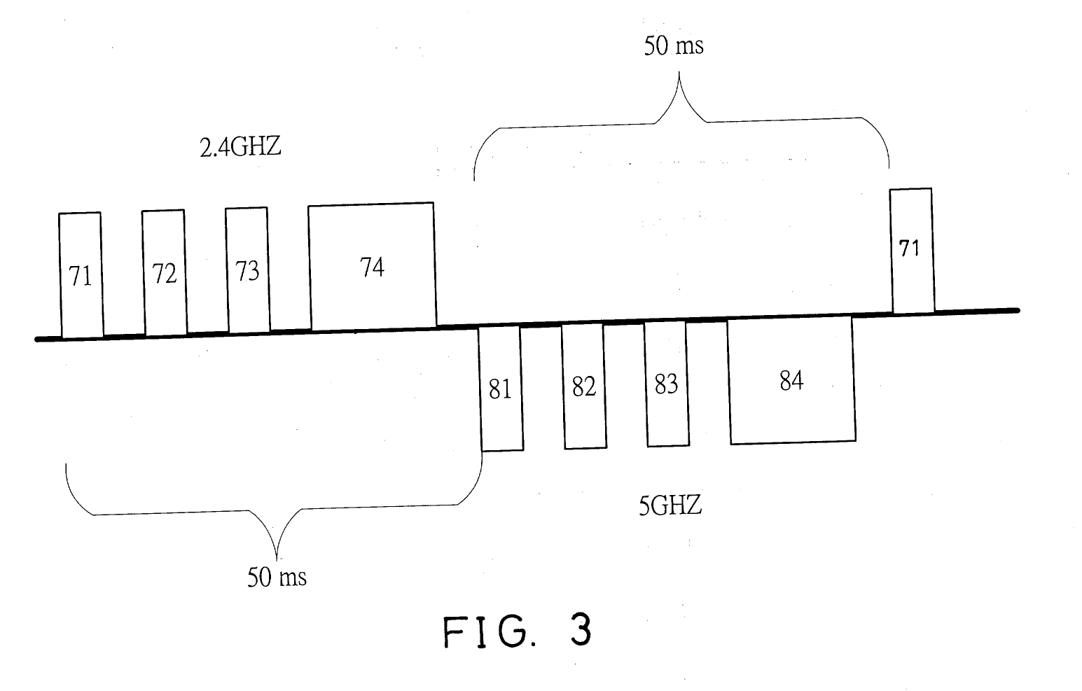

As shown in FIG. 3, in operation, when the end users 3 of low frequency (2.4 GHz, such as IEEE 802.11b or IEEE 802.11g) is coupled to or communicated with the network systems 2 via the dual or multiple wireless network access device 1, for example, the access device 1 may first issue a signal 71 to accept the coupling of the end users 3.

The end users 3 of low frequency may then send out a signal 72, when required, to request for transmitting signals. The access device 1 will then issue a respond signal 73 right away to allow the end users 3 to transmit signals 74 to the access device 1, and will terminate the transmission of the signals 74 after a period of 50 ms since issuing the signal 71.

The access device 1 will then issue a signal 81 to accept the coupling of the end users 4 of high frequency (5 GHz, such as IEEE 802.11a). The end users 4 of high frequency may then send out a signal 82, when required, to request for transmitting signals. The access device 1 will then issue a respond signal 83 right away to allow the end users 4 to transmit signals 84 to the access device 1, and will terminate the transmission of the signals 84 after a period of 50 ms since issuing the signal 81.

The access device 1 may then issue a signal 71 again, to accept the coupling of the end users 3 of low frequency (2.4 GHz, such as IEEE 802.11b or IEEE 802.11g) with the network systems 2 via the dual or multiple wireless network access device 1 again.

Accordingly, the data or information may be communicated between the end users 3 of low frequency and the network systems 2 alternatively for every 50 ms, and the data or information may also be communicated between the end users 4 of high frequency and the network systems 2 alternatively for the other every 50 ms, such that the end users 3, 4 of different frequencies may be equally and alternatively communicated with the network systems 2 for 50 ms each via the dual or multiple wireless network access device 1, without waiting until the other end users have been compled the communication of with the network systems 2.

Accordingly, the dual or multiple wireless network access device in accordance with the present invention includes an antenna device for receiving and transmitting signals of two or more different frequencies.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wireless network access device for communicating between network systems and end users of different frequencies, said wireless network access device comprising:
a processor device for coupling to the network systems,
a dual frequency wireless circuit coupled to said processor device,
a first antenna coupled to said dual frequency wireless circuit to receive and transmit signals of a frequency, and
a second antenna coupled to said dual frequency wireless circuit to receive and transmit signals of a frequency different from that of said first antenna, and to allow the end users of different frequencies to communicate with the network systems via said dual frequency wireless circuit.

2. The wireless network access device as claimed in claim 1 further comprising a wireless control device coupled between said dual frequency wireless circuit and said processor device, to transmit signals between said dual frequency wireless circuit and said processor device.
